(19) United States
(12) Patent Application Publication
(10) Pub. No.: US 2026/0237737 A1
(43) Pub. Date: Aug. 13, 2026

(54) SOLID POLYMER ELECTROLYTE FOR ALL-SOLID-STATE BATTERIES

(71) Applicant: HYDRO-QUÉBEC, Montréal (CA)

(72) Inventors: Xuewei ZHANG, St-Hubert (CA); Jean-Christophe DAIGLE, St-Bruno-de-Montarville (CA)

(21) Appl. No.: 19/152,123

(22) PCT Filed: Mar. 15, 2024
(86) PCT No.: PCT/CA2024/050319

§ 371 Date: Jul. 30, 2025

(30) Foreign Application Priority Data
Mar. 17, 2023 (CA) 3193279

(51) Int. Cl. H01M 10/0565; H01M 4/02; H01M 4/38; H01M 4/525

(52) U.S. Cl. CPC H01M 10/0565; H01M 4/382; H01M 4/525; H01M 2004/027; H01M 2004/028; H01M 2300/0082

(57) ABSTRACT

The present technology relates to solid polymer electrolyte films comprising a heterogeneous mixture of at least two different polymers, one of the two polymers being a branched polyether having at least 3 branches. Their manufacturing processes, as well as the electrochemical cells, batteries and electrochemical accumulators comprising them are also described, as well as their use.

### RELATED APPLICATION

This application claims priority under applicable law from Canadian patent application number 3,193,279 filed on Mar. 17, 2023, the contents of which are incorporated herein by reference in their entirety and for all purposes.

### TECHNICAL FIELD

The present technology relates to solid polymer electrolyte films, to their manufacturing processes and to electrochemical cells and batteries comprising them.

### BACKGROUND

Liquid electrolytes used in lithium-ion batteries are flammable and slowly degrade to form a passivation layer on the surface of the lithium film or solid electrolyte interface (SEI), irreversibly consuming lithium, which decreases the battery's coulombic efficiency. In addition, lithium anodes undergo significant morphological changes during battery cycling, and lithium dendrites are formed. Since these typically migrate through the electrolyte, they can eventually cause short circuits.

Safety concerns and the requirement for higher energy density have stimulated research for the development of an all-solid-state rechargeable lithium battery with a polymer or ceramic electrolyte, both of which are more stable with respect to metallic lithium and reduce the growth of lithium dendrites. However, some disadvantages result from the use of such solid electrolytes, e.g., loss of reactivity or ionic conductivity, poor contact between solid interfaces, etc.

There is therefore a constant need for the development of new solid electrolyte films for use in all-solid-state batteries.

### SUMMARY

According to a first aspect, the present technology relates to a solid electrolyte comprising a first polymer, a second polymer, optionally a plasticizer, and optionally an ionic organic additive, wherein the first polymer is a branched polyether with at least 3 branches, and wherein the first and second polymers are different and form a heterogeneous mixture.

In one embodiment, the first polymer is a branched polyether with at least 4 branches in a star configuration. According to another embodiment, the branches of the first polymer comprise polymer chains of alkylene oxide units, preferably the alkylene oxide units comprising ethylene oxide units, propylene oxide units or a combination of ethylene oxide and propylene oxide units.

In another embodiment, the first polymer is crosslinkable and comprises crosslinkable groups, for example located on a side chain or as a terminal group at the end of a branch, preferably as a terminal group at the end of a branch. According to yet another embodiment, the first polymer is further crosslinked, the polymer being the product of the crosslinking of crosslinkable groups, for example located on a side chain or as a terminal group at the end of a branch, preferably as a terminal group at the end of a branch of the first polymer. According to one or other of the preceding embodiments, the crosslinkable groups can be selected from the vinyl, acrylate, methacrylate, glycidyl, and mercapto groups, and a combination of at least two of these.

According to one embodiment, the first polymer has a number average molecular weight of 500 to 5 million, or 5,000 to 1,000,000, or 20,000 to 500,000. According to another embodiment, the first polymer is present at a concentration of about 5% to about 80%, about 5% to about 60%, about 5% to about 35%, or about 10% to about 30%, or about 12% to about 25%, by weight in the solid electrolyte.

According to another embodiment, the second polymer comprises a substituted polyethylene chain. In one embodiment, the second polymer comprises groups selected from fluorine, an optionally fluorinated alkyl group, an optionally substituted cycloalkyl group, an optionally substituted heterocycloalkyl group, an optionally substituted aryl group, an optionally substituted heteroaryl group, a polyether group, an optionally fluorinated alkyl ester group, a polyether ester group, or a combination of two or more thereof.

In another embodiment, the second polymer comprises a copolymer, preferably a copolymer comprising units comprising groups selected from fluorine, an optionally fluorinated alkyl group, an optionally fluorinated alkyl ester group, a polyether ester group, or a combination of two or more thereof, and optionally units comprising an optionally substituted aryl group and/or a carboxylic acid group.

According to one embodiment, the second polymer comprises a random or block copolymer or a combination of random and block copolymer, for example, the second polymer comprises a block copolymer comprising at least two blocks of different monomers and in which at least one of the two blocks comprises a random copolymer sequence.

According to yet another embodiment, the second polymer comprises at least one monomer derived from the polymerization of poly(ethylene glycol) methyl ether (meth)acrylate, (meth)acrylic acid, 1,1-difluorovinyl, tetrafluorovinyl, hexafluoropropene, 2,2,2-trifluoroethyl (meth)acrylate, styrene, divinylbenzene, or a combination of two or more thereof, preferably the second polymer comprises at least one monomer derived from the polymerization of poly(ethylene glycol) methyl ether (meth)acrylate (PEGMA), 1,1-difluorovinyl (PVDF), tetrafluorovinyl (PTFE), hexafluoropropene (HFP), 2,2,2-trifluoroethyl (meth)acrylate, or a combination of two or more thereof, and optionally a monomer derived from the polymerization of (meth)acrylic acid, styrene, and/or divinylbenzene.

In one embodiment, the second polymer comprises a polymer selected from poly[styrene-b-poly(poly(ethylene glycol) methyl ether methacrylate-co-methacrylic acid)] (PS-b-P(PEGMA-co-MAA), poly[poly(styrene-co-divinylbenzene)-b-poly(poly (ethylene glycol) methyl ether methacrylate-co-methacrylic acid)] (P (S-co-DVB)-b-P(PEGMA-co-MAA), poly(vinylidene fluoride)-co-hexafluoropropylene, and poly[(2,2,2-trifluoroethyl methacrylate)-co-(poly(ethylene glycol) methyl ether methacrylate)]], or a combination of at least two thereof. In other embodiments, the second polymer comprises poly[styrene-b-poly(poly (ethylene glycol) methyl ether methacrylate-co-methacrylic acid)] (PS-b-P(PEGMA-co-MAA), poly[poly(styrene-co-divinylbenzene)-b-poly(poly (ethylene glycol) methyl ether methacrylate-co-methacrylic acid)] (P (S-co-DVB)-b-P(PEGMA-co-MAA), or a combination thereof, or the second polymer comprises poly(vinylidene fluoride)-co-hexafluoropropylene, poly[(2,2,2-trifluoroethyl methacrylate)-co-(poly(ethylene glycol) methyl ether methacrylate), or a combination thereof.

According to one embodiment, the second polymer is a mixture of at least two polymers as previously defined, for example, the mixture of at least two polymers comprising at least poly(vinylidene fluoride)-co-hexafluoropropylene. According to another embodiment, the second polymer has a number average molecular weight of 500 to 5 million, or 5,000 to 1,000,000, or 20,000 to 500,000. In another embodiment, the second polymer is in the form of particles (e.g., microparticles, nanoparticles, picoparticles, or a mixture comprising two or more thereof), for example, in the form of powder, fibers, rods, vesicles, micelles, etc. In another embodiment, the second polymer is present at a concentration of about 3% to about 40%, about 4% to about 30%, 4% to about 25%, or about 8% to about 20%, or about 10% to about 18%, by weight in the solid electrolyte.

In another embodiment, the solid electrolyte further comprises a third polymer different from the first and second polymers. According to one embodiment, the third polymer is an optionally substituted, preferably phosphorus-containing, polysaccharide (such as cellulose fibers), or a combination thereof.

According to one embodiment, the ionic organic additive is present, preferably at a concentration of about 0.5% to about 35%, or about 2% to about 30%, or about 5% to about 20%, by weight in the solid electrolyte.

In another embodiment, the ionic organic additive is a bifunctional ionic molecule of Formula I or II:

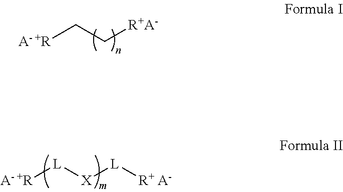

wherein,
A⁻ is a delocalized anion;
R⁺ is selected from groups —N⁺(R₁R₂R₃) and —P⁺(R₁R₂R₃);
R₁, R₂, and R₃ are independently selected from substituted or unsubstituted, linear or branched C₁₋₁₂alkyl groups; or R₁ and R₂ together with the nitrogen or phosphorous atom form a heterocycle having one or more rings and having from 3 to 12 members and R₃ is as previously defined; or R₁, R₂, and R₃ together with the nitrogen or phosphorous atom form a heteroaromatic or partially unsaturated heterocycle having one or more rings and having from 5 to 12 members;
L is a linear or branched C₂₋₄alkylene;
X is O or S;
m is a number in the range of 1 to 6; and
n is a number in the range of 1 to 11.

According to one embodiment, the delocalized anion is selected from hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide (FTFSI⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato) borate (BOB⁻), nitrate (NO₃⁻), perchlorate (ClO₄⁻), hexafluoroarsenate (AsF₆⁻), trifluoromethanesulfonate (CF₃SO₃⁻ or ⁻OTf), fluoroalkylphosphate ([PF₃(CF₂CF₃)₃]⁻ or FAP⁻), tetrakis(trifluoroacetoxy) borate ([B(OCOCF₃)₄]⁻ or TFAB⁻), bis(1,2-benzenediolato (2-)—O,O′) borate ([B(C₆O₂)₂]⁻ or BBB⁻), difluoro (oxalato) borate (BF₂(C₂O₄) or FOB⁻), and an anion of formula BF₂O₄R^{x} (R^{x}=C₂₋₄alkyl), preferably selected from hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide (FTFSI⁻), tetrafluoroborate (BF₄⁻), and trifluoromethanesulfonate (CF₃SO₃⁻ or ⁻OTf), more preferably bis(trifluoromethanesulfonyl)imide (TFSI⁻).

According to another embodiment, R⁺ is a —N⁺(R₁R₂R₃) group. In one embodiment, R₁, R₂, and R₃ are independently selected from substituted or unsubstituted, linear or branched C₁₋₁₂alkyl groups. In another embodiment, R₁, R₂, and R₃ are independently selected from linear or branched C₁₋₁₂alkyl groups, or at least one of R₁, R₂, or R₃ is substituted by a halogen atom or an alkoxy, ether, ester, or siloxy group. In yet another embodiment, R₁ and R₂ together with the nitrogen atom form a heterocycle having one or more rings and having from 3 to 12 members and R₃ is as defined in claim 25, preferably R₃ is a C₁₋₁₂alkyl, or a C₁₋₄alkyl. According to another alternative, R₁, R₂, and R₃ together with the nitrogen atom form a heteroaromatic or partially unsaturated heterocycle having one or more rings and having from 5 to 12 members. According to some embodiments, R⁺ is selected from:

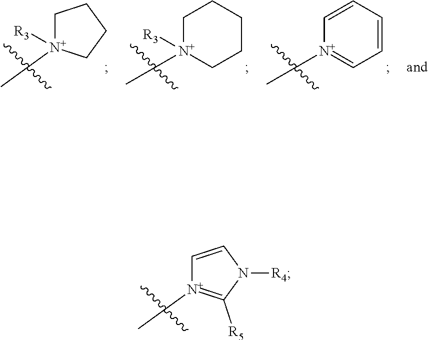

wherein R₃ is as defined in claim 25, R₄ is a substituted or unsubstituted, linear or branched C₁₋₁₂alkyl, C₁₋₁₂alkenyl or C₁₋₁₂alkynyl group, R₅ is a hydrogen atom or a substituted or unsubstituted, linear or branched C₁₋₁₂alkyl, C₁₋₁₂alkenyl or C₁₋₁₂alkynyl group, and the heterocycle is optionally substituted.

According to one embodiment, R₄ is a C₁₋₄alkyl group. According to another embodiment, R₅ is a C₁₋₄alkyl group. According to yet another embodiment, R₃ is an unsubstituted C₁₋₄alkyl group, for example, preferably selected from a methyl group, an ethyl group, an n- or i-propyl group, and an n-, i-, s- or t-butyl group.

In some embodiments, R⁺ is a —P⁺(R₁R₂R₃) group. In one embodiment, R₁, R₂, and R₃ are independently selected from substituted or unsubstituted, linear or branched C₁₋₁₂alkyl groups. In another embodiment, R₁, R₂, and R₃ are independently selected from linear or branched C₁₋₁₂alkyl groups, or at least one of R₁, R₂, or R₃ is substituted with a halogen atom or an alkoxy, ether, ester, or siloxy group.

In one embodiment, n in Formulae I and II is a number in the range of 2 to 10, or 3 to 8, or 4 to 6.

In another embodiment, the ionic bifunctional molecule is 1,1′-(1,6-hexamethylene)bis(1-methylpyrrolidinium) bis(trifluoromethanesulfonyl)imide, or 1,1′-(1,12-dodecamethylene) bis(1-methylpyrrolidinium) bis(trifluoromethanesulfonyl)imide, or 1,1′-(2,2′-(ethylenedioxy) diethane) bis(1-methylpyrrolidinium) bis(trifluoromethanesulfonyl)imide, or 1,1′-(thiol bis(1,2-ethane)) bis(1-methylpyrrolidinium) bis(trifluoromethanesulfonyl)imide, or 3,3′-(1,6-hexamethylene)bis(1,2-dimethylimidazolium) bis(trifluoromethanesulfonyl)imide.

According to another embodiment, the plasticizer is present, preferably at a concentration of about 5% to about 50%, or about 10% to about 40%, or about 20% to about 30%, by weight in the solid electrolyte. In one embodiment, the plasticizer is selected from liquids of the type glycol diethers (such as tetraethylene glycol dimethyl ether (TEGDME)), carbonate esters, ionic liquids, and the like, preferably a glycol diether-type liquid (such as TEGDME).

According to yet another embodiment, the solid electrolyte further comprises an alkali metal salt, preferably a lithium salt, preferably at a concentration of about 5% to about 40%, or about 15% to about 40%, or about 20% to about 35%, by weight in the solid electrolyte. In one embodiment, wherein the salt comprises a cation of an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide ((FSI) (TFSI)⁻), 2-trifluoromethyl-4,5-dicyanoimidazolate (TDI), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato) borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy) borate [B(OCOCF₃)₄]⁻ (TFAB⁻), bis(1,2-benzenediolato (2-)—O,O′) borate [B(C₆O₂)₂]⁻ (BBB⁻), difluoro (oxalato) borate (BF₂(C₂O₄)⁻) (FOB⁻), an anion of formula BF₂O₄Rₓ⁻ (where Rₓ=C₂₋₄alkyl), and any combination thereof, e.g., LiTFSI or LiFSI.

According to another aspect, the present technology relates to an electrochemical cell comprising a negative electrode, a positive electrode and an electrolyte, wherein the electrolyte is as defined herein.

According to one embodiment, the positive electrode comprises a positive electrode material comprising a positive electrode electrochemically active material, preferably the positive electrode material being on a current collector.

In one embodiment, the positive electrode electrochemically active material is selected from metal phosphates, lithiated metal phosphates, metal oxides, and lithiated metal oxides. In another embodiment, the positive electrode electrochemically active material is LiM′PO₄ where M′ is Fe, Ni, Mn, Co, or a combination of at least two thereof, LiV₃O₈, V₂O₅F, LiV₂O₅, LiMn₂O₄, Li_{1+w}M″O₂₋ₐX_{b}, where M″ is Mn, Co, Ni, Mg, Al, Zr, W, Ti, Nb, V, Fe, Mo or a combination thereof (such as NMC, Li_{1+w}MnₓCo_{y}Ni_{z}O₂) and X is F, S or a combination thereof, Li_{1+w}(NIM′″)O₂ (where M′″ is Mn, Co, Mg, Al, W, Fe, Cr, Ti, Zr, Nb, Mo, V or a combination thereof), elemental sulfur, selenium or iodine, iron (III) fluoride, copper (II) fluoride, lithium iodide, carbon-based active materials such as graphite, organic cathode active materials, or a combination of two or more of these, when compatible with each other.

According to another embodiment, the positive electrode material further comprises an electronically conductive material, a binder, a salt, an ionic organic additive, and/or inorganic particles.

In another embodiment, the negative electrode comprises a negative electrode material comprising a negative electrode electrochemically active material, preferably the negative electrode material being on a current collector.

According to one embodiment, the negative electrode electrochemically active material comprises a metal film comprising an alkali or alkaline earth metal or an alloy comprising an alkali or alkaline earth metal, for example, an alkali metal selected from lithium and sodium, or an alloy comprising lithium or sodium, preferably lithium or an alloy comprising lithium.

In an alternative embodiment, the negative electrode electrochemically active material comprises an intermetallic compound (e.g., SnSb, TiSnSb, Cu₂Sb, AlSb, FeSb₂, FeSn₂ and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and combinations thereof, when compatible. In one embodiment, the metal oxide is selected from compounds of formulae M″″_{b}O_{c} (where M″″ is Ti, Mo, Mn, Ni, Co, Cu, V, Fe, Zn, Nb, or a combination thereof; and b and c are numbers such that the c:b ratio is in the range of 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄) and LiM″″′O (where M″″′ is Ti, Mo, Mn, Ni, Co, Cu, V, Fe, Zn, Nb, or a combination thereof) (e.g., a lithium titanate (such as Li₄Ti₅O₁₂) or a lithium and molybdenum oxide (such as Li₂Mo₄O₁₃)).

According to another embodiment, the negative electrode material further comprises an electronically conductive material, a binder, a salt, an ionic organic additive, and/or inorganic particles.

According to another aspect, the present technology also relates to a battery comprising at least one electrochemical cell as defined herein. According to one embodiment, the battery is selected from the group consisting of a lithium battery, a lithium-ion battery, a sodium battery, a sodium-ion battery, a potassium battery, a potassium-ion battery, a magnesium battery, and a magnesium-ion battery, preferably a lithium battery or a lithium-ion battery.

### BRIEF DESCRIPTION OF THE FIGURES

FIG. 1 shows a transmission electron microscopy (TEM) image of the PS-NP-2 nanoparticles prepared according to Example 1 (c).

FIG. 2 shows the normalized heat flux curves versus temperature for Film 6 prepared in Example 1 (f) compared to films of PVDF-HFP and of a PVDF-HFP/additive blend.

FIG. 3 shows a graph of the Young's modulus of the Film 6 membrane prepared in Example 1 (f).

FIG. 4 shows the ionic conductivity of symmetrical Cells 1 to 4 measured as in Example 3 (b).

FIG. 5 shows the discharge capacity results as a function of the number of cycles for complete Batteries 1 to 9 comprising Films 2 to 10, respectively, when cycling as described in Example 3 (d).

### DETAILED DESCRIPTION

All technical and scientific terms and expressions used herein have the same definitions as those generally understood by the person skilled in the art of the present technology. The definition of some terms and expressions used are nevertheless provided below.

When the term “about” is used herein, it means approximately, in the region of, or around. For example, when the term “about” is used in connection with a numerical value, it modifies it above and below by a variation of 10% from its nominal value. This term may also take into account, for example, the experimental error of a measuring device or rounding.

When a range of values is mentioned in the present application, the lower and upper limits of the range are, unless otherwise specified, always included in the definition. When a range of values is mentioned in the present application, then all intermediate ranges and sub-ranges, as well as the individual values included in the ranges of values, are included in the definition.

When the article “a” is used to introduce an element in the present application, it does not have the meaning of “one only”, but rather of “one or more”. Of course, where the description states that a particular step, component, element, or feature “may” or “could” be included, that particular step, component, element, or feature is not required to be included in every embodiment.

The chemical structures described herein are drawn according to the conventions of the field. Also, when an atom, such as a carbon atom, as drawn appears to include an incomplete valence, then it is assumed that the valence is satisfied by one or more hydrogen atoms even if they are not explicitly drawn.

As used herein, the term “alkyl” refers to optionally substituted saturated hydrocarbon groups having from 1 to 12 carbon atoms (unless indicated otherwise), including linear or branched alkyl groups, preferably from 1 to 6 carbon atoms. Non-limiting examples of alkyls may include the groups methyl, ethyl, propyl, butyl, pentyl, hexyl, heptyl, octyl, nonyl, decyl, isopropyl, tert-butyl, sec-butyl, isobutyl, and analogs. Similarly, an “alkylene” group refers to an alkyl group located between groups, for example, methylene, ethylene, propylene, butylene, etc. The terms “Cₘ-Cₙalkyl” and “Cₘ-Cₙalkylene” respectively refer to an alkyl or alkylene group having from the indicated number “m” to the indicated number “n” of carbon atoms.

As used herein, the term “cycloalkyl” used here means a group comprising one or more saturated or partially unsaturated (non-aromatic) carbocyclic rings comprising from 3 to 15 members in a monocyclic or polycyclic ring system, including spiro (sharing one atom), fused (sharing at least one bond), or bridged carbocycles and may be optionally substituted. Examples of cycloalkyl groups include, without limitation, cyclopropyl, cyclobutyl, cyclopentyl, cyclopenten-1-yl, cyclopenten-2-yl, cyclopenten-3-yl, cyclohexyl, cyclohexen-1-yl, cyclohexen-2-yl, cyclohexen-3-yl, cycloheptyl and so on. When the cycloalkyl group is located between two functional groups, the term cycloalkylene may also be used. The terms “Cₘ-Cₙcycloalkyl” and “Cₘ-Cₙcycloalkylene” refer respectively to a cycloalkyl or cycloalkylene group having from the indicated number “m” to the indicated number “n” of carbon atoms.

As used herein, the term “heterocycloalkyl” refers to a group comprising a saturated or partially unsaturated (non-aromatic) carbocyclic ring comprising from 3 to 15 members in a monocyclic or polycyclic system, including spiro (sharing one atom), fused (sharing at least one bond), or bridged carbocycles and may be optionally substituted, and having carbon atoms and from 1 to 4 heteroatoms (e.g., N, O, S, or P) or groups containing such heteroatoms (e.g., NH, NRₓ (Rₓ is an alkyl, acyl, aryl, heteroaryl, or cycloalkyl group), PO₂, SO, SO₂, and other similar groups). Heterocycloalkyl groups may be linked to a carbon atom or a heteroatom (e.g., via a nitrogen atom) where possible. The term heterocycloalkyl includes both unsubstituted and substituted heterocycloalkyl groups. When the heterocycloalkyl group is located between two functional groups, the term heterocycloalkylene may also be used. The terms “Cₘ-Cₙheterocycloalkyl” and “Cₘ-Cₙheterocycloalkylene” refer, respectively, to a heterocycloalkyl or heterocycloalkylene group having from the indicated number “m” to the indicated number “n” of ring atoms, including carbon atoms and heteroatoms.

As used herein, the term “aromatic” or “aryl” refers to an aromatic group having 4n+2 conjugated π(pi) electrons in which n is a number from 1 to 3, in a monocyclic group, or a fused bicyclic or tricyclic system having a total of six to 15 ring members, in which at least one of the rings in a system is aromatic. The terms “aryl” or “aromatic” refer to both monocyclic and conjugated polycyclic systems. The terms “aryl” or “aromatic” also include substituted or unsubstituted groups. Examples of aryl groups include, without limitation, phenyl, benzyl, phenethyl, 1-phenylethyl, tolyl, naphthyl, biphenyl, terphenyl, indenyl, benzocyclooctenyl, benzocycloheptenyl, azulenyl, acenaphthylenyl, fluorenyl, phenanthrenyl, anthracenyl, perylenyl, and so on. The terms “Cₘ-Cₙaryl” and “Cₘ-Cₙarylene” refer respectively to an aryl or arylene group having from the indicated number “m” to the indicated number “n” of carbon atoms.

The term “heteroaromatic” or “heteroaryl” refers to an aromatic group having 4n+2 conjugated π(pi) electrons in which n is a number from 1 to 3, for example having from 5 to 18 ring atoms, preferably 5, 6, or 9 ring atoms; and having, in addition to carbon atoms, from 1 to 5 heteroatoms selected from oxygen, nitrogen and sulfur or groups containing such heteroatoms or groups containing such heteroatoms (for example, NH and NRₓ (Rₓ is an alkyl, acyl, aryl, heteroaryl or cycloalkyl group), SO, and other similar groups). A polycyclic ring system includes at least one heteroaromatic ring. Heteroaryls may be directly attached or linked by a C₁-C₃alkyl group (also called heteroarylalkyl or heteroaralkyl). Heteroaryl groups may be linked through a carbon atom or to a heteroatom of the ring (e.g., via a nitrogen atom), where possible. The terms “Cₘ-Cₙheteroaryl” and “Cₘ-Cₙheteroarylene” refer respectively to a heteroaryl or heteroarylene group having from the indicated number “m” to the indicated number “n” of ring atoms, including carbon atoms and heteroatoms.

Generally, the term “substituted” means that one or more hydrogen atoms on the designated group are replaced by a suitable substituent. The substituents or combinations of substituents contemplated in the present description are those resulting in the formation of a chemically stable compound. Examples of substituents include halogen atoms (such as fluorine) and the groups hydroxyl, oxo, alkyl, alkoxy, alkoxyalkyl, nitrile, azido, carboxylate, alkoxycarbonyl, alkylcarbonyl, primary, secondary or tertiary amine, amide, nitro, silane, siloxane, thiocarboxylate, sulfonyl, sulfonate, alkenyl, alkynyl, aryl, heteroaryl, cycloalkyl, heterocycloalkyl, or a combination thereof.

The terms “monomer”, “monomer unit” and “unit” as used herein refer to a molecule that can undergo polymerization or to that same molecule present in the resulting polymer or polymer chain.

The term “polymerization” as used herein refers to the process of transforming a monomer or mixture of monomers into a polymer, the structure of which essentially comprises the multiple repetition of units derived from the monomer(s).

The term “polymer” means a macromolecule comprising a multiple repetition of units or patterns derived from one or more monomers and/or macromonomers. Similarly, a “polymer chain” will refer to a polymeric part of a polymer, for example, a main chain or a branch of a polymer.

The expressions “crosslinkable function” or “crosslinkable group” of a polymer describe a group having at least one function which can react to form crosslinks between the main chains and/or branches of a polymer and thereby forming a three-dimensional network.

The term “(meth)acrylate” or “(meth)acrylic” designates an acrylate or acrylic group substituted or not by a methyl, that is to say an acrylate, methacrylate, acrylic, or methacrylic group.

In the context of the present document, “comprised between x and y” or “from x to y” means a range in which the limits x and y are included unless otherwise indicated. For example, the range “comprised between 1 and 50” also includes the values 1 and 50.

The present document describes more particularly electrolyte compositions intended for the manufacture of solid polymer electrolytes, for example, in the form of films. These solid electrolytes comprise at least a first and a second polymer, and optionally a plasticizer and/or an ionic organic additive, in which the first and second polymers are different and form a heterogeneous mixture. It is understood that the first or second polymer may comprise a mixture of polymers, more particularly, the second polymer may comprise a mixture of two polymers as described herein. According to a preferred example, the solid electrolyte excludes the addition of inorganic particles such as ceramics, glass-ceramics, etc.

The first polymer is generally a branched polymer with at least 3 branches, preferably a polyether. For example, the first polymer may be a branched polyether with at least 4 branches, for example in a star configuration. In some examples, the arms of the first polymer comprise polymer chains of alkylene oxide units, preferably the alkylene oxide units comprising ethylene oxide, propylene oxide or a combination of ethylene oxide and propylene oxide units.

According to some examples, the first polymer is crosslinkable and comprises crosslinkable groups, for example located on a side chain or as a branch end terminal group, preferably as a branch end terminal group. In other examples, the first polymer is crosslinked, the polymer being the product of the crosslinking of crosslinkable groups, for example located on a side chain or as a branch end terminal group, preferably as a branch end terminal group of the first polymer. Non-limiting examples of crosslinkable groups include the groups vinyl, acrylate, methacrylate, glycidyl, mercapto, or a combination of two or more thereof.

The molecular weight of the first polymer, for example, its number-average molecular weight, may be in the range of 500 to 5,000,000, or 5,000 to 1,000,000, or 20,000 to 500,000. It is of course understood that in the case of a crosslinked polymer, this molecular mass is calculated before crosslinking.

The first polymer may be present in the solid electrolyte at a concentration of about 5% to about 80%, about 5% to about 60%, about 5% to about 35%, or about 10% to about 30%, or about 12% to about 25%, by weight in the solid electrolyte.

As described above, the second polymer is different from the first polymer and forms a heterogeneous mixture, i.e., it is non-miscible therein. The second polymer may consist of a single polymer or a mixture of polymers forming a heterogeneous mixture with the first polymer. The second polymer preferably comprises a substituted polyethylene chain. For example, the polyethylene chain may be substituted with a halogen atom (such as fluorine), an optionally fluorinated alkyl group, an optionally substituted cycloalkyl group, an optionally substituted heterocycloalkyl group, an optionally substituted aryl group, an optionally substituted heteroaryl group, a polyether group, an optionally fluorinated alkyl ester group, a polyether ester group, or a combination of two or more thereof.

In some examples, the second polymer comprises a copolymer. For example, the copolymer may comprise units substituted with groups selected from a halogen atom (such as fluorine), an optionally fluorinated alkyl group, an optionally fluorinated alkyl ester group, a polyether ester group, or a combination of two or more thereof, and optionally units comprising an optionally substituted aryl group and/or a carboxylic acid group.

The second polymer may comprise a random copolymer, a block copolymer, or a combination of a random and block copolymer. For example, the block copolymer may comprise at least two blocks comprising different monomers and wherein at least one of the two blocks comprises a random copolymer sequence.

Non-limiting examples of monomers that may be used in the preparation of the second polymer include poly(ethylene glycol) methyl ether (meth)acrylate, (meth)acrylic acid, 1,1-difluorovinyl, tetrafluorovinyl, hexafluoropropene, 2,2,2-trifluoroethyl (meth)acrylate, styrene, divinylbenzene, or a combination of two or more thereof, preferably the second polymer comprises at least one monomer derived from the polymerization of poly(ethylene glycol) methyl ether (meth)acrylate (PEGMA), 1,1-difluorovinyl, tetrafluorovinyl, hexafluoropropene (HFP), 2,2,2-trifluoroethyl (meth)acrylate, or a combination of two or more thereof, and optionally a monomer derived from the polymerization of (meth)acrylic acid, styrene, and/or divinylbenzene.

Examples of second polymer include, but are not limited to, polymers:
poly[styrene-b-poly(poly (ethylene glycol) methyl ether methacrylate-co-methacrylic acid)] (PS-b-P(PEGMA-co-MAA);
poly[poly(styrene-co-divinylbenzene)-b-poly(poly (ethylene glycol) methyl ether methacrylate-co-methacrylic acid)] (P (S-co-DVB-b-P(PEGMA-co-MAA);
poly(vinylidene fluoride)-co-hexafluoropropylene (PVDF-HFP);
poly[(2,2,2-trifluoroethyl methacrylate)-co-(poly(ethylene glycol) methyl ether methacrylate)] (PTFEMA-co-PEGMA);
   or a combination of at least two thereof.

In some examples, the second polymer comprises poly[styrene-b-poly(poly (ethylene glycol) methyl ether methacrylate-co-methacrylic acid)] (PS-b-P(PEGMA-co-MAA), poly[poly(styrene-co-divinylbenzene)-b-poly(poly (ethylene glycol) methyl ether methacrylate-co-methacrylic acid)] (P (S-co-DVB)-b-P(PEGMA-co-MAA), or a combination of both. For instance, the second polymer comprises poly[poly(styrene-co-divinylbenzene)-b-poly(poly (ethylene glycol) methyl ether methacrylate-co-methacrylic acid)] (P (S-co-DVB)-b-P(PEGMA-co-MAA). According to other examples, the second polymer comprises poly(vinylidene fluoride)-co-hexafluoropropylene, poly[(2,2,2-trifluoroethyl methacrylate)-co-(poly (éthylène glycol) methyl ether methacrylate), or a combination of both.

According to some examples, the second polymer is a mixture of at least two of the polymers as defined for the second polymer. For instance, the mixture of at least two polymers may include poly(vinylidene fluoride)-co-hexafluoropropylene and one of the polymers described above.

The molecular weight of the second polymer, for example, its number-average molecular weight, may be in the range of 500 to 5 million, or 5,000 to 1,000,000, or 20,000 to 500,000.

The second polymer is preferably in the form of particles (e.g., microparticles, nanoparticles, picoparticles, or a mixture comprising two or more thereof), powder, fibers, rods, vesicles, micelles, etc. when mixed with the first polymer. It may also be dissolved in a solvent in which it is miscible.

The weight concentration of the second polymer (or combination of second polymers) in the solid electrolyte is preferably from about 3% to about 40%, from about 4% to about 30%, from about 4% to about 25%, or from about 8% to about 20%, or from about 10% to about 18%, by weight in the solid electrolyte.

In some examples, the solid electrolyte further comprises a third polymer different from the first and second polymers. For example, the third polymer may be an optionally substituted, preferably phosphorus-containing, polysaccharide (such as cellulose fibers), or a combination thereof.

According to some embodiments, the ionic organic additive is present in the composition of the solid electrolyte. For example, it may be present at a concentration of about 0.5% to about 35%, or about 2% to about 30%, or about 5% to about 20%, by weight in the solid electrolyte.

The ionic organic additive may be in liquid or solid form and may be monofunctional or multifunctional, preferably bifunctional. Examples of organic additives include the ionic compounds described in patent applications WO2022/165598 and WO2023/133642. For example, the ionic organic additive may comprise an ionic bifunctional molecule of Formula I or II:

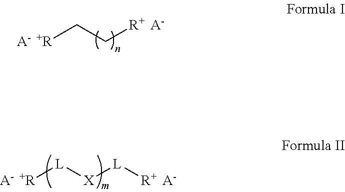

wherein,
A⁻ is a delocalized anion;
R⁺ is selected from groups —N⁺(R₁R₂R₃) and —P⁺(R₁R₂R₃);
R₁, R₂, and R₃ are independently selected from a substituted or unsubstituted, linear or branched C₁₋₁₂alkyl group; or R₁ and R₂ together with the nitrogen or phosphorous atom form a heterocycle having one or more rings and having from 3 to 12 members and R₃ is as previously defined; or R₁, R₂, and R₃ together with the nitrogen or phosphorous atom form a heteroaromatic or partially unsaturated heterocycle having one or more rings and having from 5 to 12 members;
L is a linear or branched C₂₋₄alkylene;
X is O or S;
m is a number in the range of 1 to 6; and
n is a number in the range of 1 to 11.

Examples of delocalized anions include, but are not limited to, hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide (FTFSI⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato) borate (BOB⁻), nitrate (NO₃⁻), perchlorate (ClO₄⁻), hexafluoroarsenate (AsF₆⁻), trifluoromethanesulfonate (CF₃SO₃⁻ or ⁻OTf), fluoroalkylphosphate ([PF₃(CF₂CF₃)₃]⁻ or FAP), tetrakis(trifluoroacetoxy) borate ([B(OCOCF₃)₄]⁻ or TFAB⁻), bis (1,2-benzenediolato (2-)—O,O′) borate ([B(C₆O₂)₂]⁻ or BBB⁻), difluoro (oxalato) borate (BF₂(C₂O₄) or FOB⁻), and an anion of formula BF₂O₄R^{x} (R^{x}=C₂₋₄alkyl), preferably PF₆⁻, TFSI⁻, FSI⁻, FTFSI⁻, BF₄⁻, or CF₃SO₃⁻, more preferably TFSI⁻.

According to some examples, R⁺ is a —N⁺ (R₁R₂R₃) group, preferably R₁, R₂, and R₃ being defined according to one of the following alternatives:
R₁, R₂, and R₃ are independently selected from substituted or unsubstituted, linear or branched C₁₋₁₂alkyl groups;
R₁, R₂, and R₃ are independently selected from linear or branched C₁₋₁₂alkyl groups, or at least one of R₁, R₂, or R₃ is substituted by a halogen atom or an alkoxy, ether, ester, or siloxy group;
R₁ and R₂ together with the nitrogen atom form a heterocycle having one or more rings and having from 3 to 12 members and R₃ is as defined above, preferably R₃ is a C₁₋₁₂alkyl, or a C₁₋₄alkyl; or
R₁, R₂, and R₃ together with the nitrogen atom form a heteroaromatic or partially unsaturated heterocycle having one or more rings and having from 5 to 12 members.

According to some embodiments, R⁺ may be selected from:

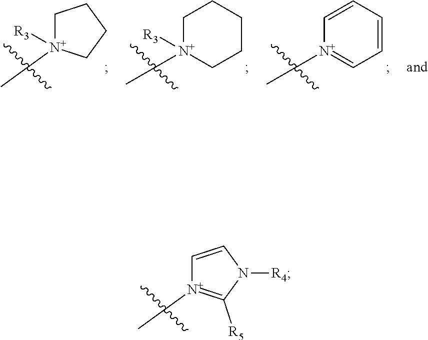

wherein R₃ is as defined above, R₄ is a substituted or unsubstituted, linear or branched C₁₋₁₂alkyl, C₁₋₁₂alkenyl or C₁₋₁₂alkynyl group, preferably a C₁₋₄alkyl group, R₅ is a hydrogen atom or a substituted or unsubstituted, linear or branched C₁₋₁₂alkyl, C₁₋₁₂alkenyl or C₁-12alkynyl group, and the heterocycle is optionally substituted preferably a C₁₋₄alkyl group. For instance, R₃ may be an unsubstituted C₁₋₄alkyl group (such as a methyl, ethyl, n- or i-propyl, or n-, i-, s- or t-butyl group).

According to alternative embodiments, R⁺ is a —P⁺ (R₁R₂R₃) group, preferably where:
R₁, R₂, and R₃ are independently selected from substituted or unsubstituted, linear or branched C₁₋₁₂alkyl groups; or
R₁, R₂, and R₅ are independently selected from linear or branched C₁₋₁₂alkyl groups, or at least one of R₁, R₂, or R₃ is substituted with a halogen atom or an alkoxy, ether, ester, or siloxy group.

According to one example, the ionic organic additive is of Formula I and the variable n is a number in the range of from 2 to 10, or from 3 to 8, or from 4 to 6.

Non-limiting examples of ionic organic additives include 1,1′-(1,6-hexamethylene)bis(1-methylpyrrolidinium) bis(trifluoromethanesulfonyl)imide, 1,1′-(1,12-dodecamethylene) bis(1-methylpyrrolidinium) bis(trifluoromethanesulfonyl)imide, 1,1′-(2,2′-(ethylenedioxy) diethane) bis(1-methylpyrrolidinium) bis(trifluoromethanesulfonyl)imide, 1,1′-(thiol bis(1,2-ethane)) bis(1-methylpyrrolidinium) bis(trifluoromethanesulfonyl)imide, 3,3′-(1,6-hexamethylene)bis(1,2-dimethylimidazolium) bis(trifluoromethanesulfonyl)imide, or a combination of one or more thereof.

In some examples, the solid electrolyte further comprises a plasticizing agent such as a non-reactive, relatively high-boiling organic liquid. The plasticizing agent may be present, for example, at a concentration of about 5% to about 50%, or about 10% to about 40%, or about 20% to about 30%, by weight in the solid electrolyte. It is understood that the concentration of plasticizing agent is adjusted so that the manufactured electrolyte film remains solid. Examples of plasticizers include, without limitation, liquids of the type glycol diether (such as tetraethylene glycol dimethyl ether (TEGDME, also known as tetraglyme)), carbonate esters (such as propylene carbonate, ethylene carbonate, fluoroethylene carbonate), lactones (such as γ-butyrolactone), adiponitrile, ionic liquids, and the like, preferably a glycol diether-type liquid (such as TEGDME).

According to some examples, the solid electrolyte further comprises a salt, such as an alkali metal salt, preferably a lithium salt, preferably at a concentration of about 5% to about 40%, or about 15% to about 40%, or about 20% to about 35%, by weight in the solid electrolyte. Non-limiting examples of salts include a cation of an alkali metal (preferably lithium), and an anion selected from the anions hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide ((FSI) (TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato) borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy) borate [B(OCOCF₃)₄]⁻ (TFAB⁻), bis(1,2-benzenediolato (2-)—O,O′) borate [B(CO₂)₂]⁻ (BBB⁻), difluoro (oxalato) borate (BF₂(C₂O₄)⁻) (FOB⁻), an anion of formula BF₂O₄Rₓ⁻ (where Rₓ=C₂₋₄alkyl), and one their combinations, e.g., LiTFSI or LiFSI.

This document also describes processes for preparing the solid electrolyte film as defined herein. For example, the method comprises the steps of:
a) mixing of the first polymer, the second polymer, optionally a plasticizer, optionally an ionic organic additive, optionally a salt, and optionally a solvent to obtain a mixture;
b) applying the mixture obtained in (a) on a substrate to form a spread layer;
c) optionally eliminating the solvent.

In some examples, the process further comprises a step of preparing the first and/or second polymer, preferably preparing the second polymer. Step (a) may comprise sequential mixing steps. For example, when a plasticizer, a salt and/or an additive of the ionic organic additive type is included, one or more of these may be mixed with one of the two polymers or precursors thereof prior to its formation and prior to mixing with the other of the two polymers.

The solvent when present is preferably an inert organic solvent, preferably relatively volatile, for example, an ether (such as tetrahydrofuran), a ketone (such as acetone), etc.

Step (b) of the process may be carried out by conventional spreading techniques, including doctor blade coating, comma coating, reverse-comma coating, printing such as gravure coating, slot-die coating, spray deposition, dipping, drop-casting, mold casting, extrusion coating, spin coating, etc. Preferably, step (b) is carried out by a coating method.

According to some examples, at least one of the first and second polymers comprises crosslinkable groups, preferably the first polymer. The method may then comprise a crosslinking step, for example, by heat treatment, by irradiation (such as by UV, microwave, gamma rays, X-rays, electron beam), or a combination of the two, optionally in the presence of a crosslinking agent which will be added in step (a). The crosslinking step is carried out after step (b) or after step (c) when the latter is present.

The present technology also relates to electrochemical cells comprising the solid electrolyte as described herein, between a negative electrode and a positive electrode.

For example, the positive electrode comprises a positive electrode material, which comprises a positive electrode electrochemically active material, optionally on a current collector. For example, the positive electrode electrochemically active material may be selected from metal phosphates, lithium metal phosphates, metal oxides, and lithium metal oxides. Examples of positive electrode electrochemically active material may also include LiM′PO₄ where M′ is Fe, Ni, Mn, Co, or a combination of at least two thereof, LiV₃O₈, V₂O₅F, LiV₂O₅, LiMn₂O₄, Li_{1+w}M″O₂₋ₐX_{b}, where M″ is Mn, Co, Ni, Mg, Al, Zr, W, Ti, Nb, V, Fe, Mo or a combination thereof (such as NMC, Li_{1+w}MnₓCo_{y}Ni_{z}O₂) and X is F, S or a combination thereof, Li_{1+w}(NiM′″)O₂ (where M″′ is Mn, Co, Mg, Al, W, Fe, Cr, Ti, Zr, Nb, Mo, V or a combination thereof), elemental sulfur, selenium or iodine, iron (III) fluoride, copper (II) fluoride, lithium iodide, carbon-based active materials, organic cathode active materials, or a combination of two or more of these, if compatible with each other.

The positive electrode electrochemically active material may be in the form of particles which are optionally coated (e.g., of polymer, ceramic, carbon, or a combination of two or more thereof).

The positive electrode material may also further comprise a binder, an electronically conductive material, a salt, an ionic organic additive, inorganic particles, or a combination of two one more thereof.

The negative electrode in turn comprises a negative electrode material, which comprises a negative electrode electrochemically active material, optionally on a current collector.

In some examples, the negative electrode electrochemically active material film is a metal film comprising an alkali or alkaline earth metal or an alloy comprising an alkali or alkaline earth metal. For example, the metal film is selected from a lithium, lithium alloy, sodium, sodium alloy, magnesium, or magnesium alloy film, preferably a lithium or sodium film or an alloy comprising one of the two, preferably a lithium or lithium alloy film. A lithium alloy preferably comprises at least 50%, or at least 75%, or at least 90%, or at least 95%, or at least 99% by weight of lithium.

When the metal film is a lithium alloy, it may, in addition to lithium, comprise an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel, and germanium (e.g., Zr, Cu, Ag, Bi, Co, Zn, Al, Si, Sn, Sb, Cd, Hg, Pb, Mn, B, In, Tl, Ni, or Ge).

Alternatively, the negative electrode electrochemically active material may comprise an intermetallic compound (e.g., SnSb, TiSnSb, Cu₂Sb, AlSb, FeSb₂, FeSn₂ and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and combinations thereof, when compatible. For instance, the metal oxide may be selected from compounds of formulae M″″_{b}O_{c} (where M″″ is Ti, Mo, Mn, Ni, Co, Cu, V, Fe, Zn, Nb, or a combination thereof; and b and c are numbers such that the c:b ratio is in the range of 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄) and LiM″″′O (where M″″′ is Ti, Mo, Mn, Ni, Co, Cu, V, Fe, Zn, Nb, or a combination thereof) (e.g., a lithium titanate (such as Li₄Ti₅O₁₂) or a lithium and molybdenum oxide (such as Li₂Mo₄O₁₃)).

The negative electrode electrochemically active material may be in the form of particles which are optionally coated (e.g., of polymer, ceramic, carbon, or a combination of two or more thereof).

The negative electrode material may also include a binder, an electronically conductive material, a salt, an ionic organic additive, inorganic particles, or a combination of two or more of these.

The binder when present in the negative and/or positive electrode may comprise a polymer as defined for the first and second polymers. The polymer of the binder may comprise ion solvating units, in particular of lithium ions. Examples of solvating polymers include linear or branched polyether polymers (for example, PEO, PPO, or EO/PO copolymer), poly (dimethylsiloxanes), poly (alkylene carbonates), poly (alkylene sulfones), poly (alkylene sulfamides), polyurethanes, poly(vinyl alcohols), polyacrylonitriles, polymethyl methacrylates, and copolymers thereof, and optionally comprising crosslinked units originating from crosslinkable functions (such as acrylate, methacrylate, vinyl, glycidyl, mercapto functions, etc.).

The binder, when present, may also be a rubber-type electrode binder such as SBR (styrene-butadiene rubber), NBR (acrylonitrile-butadiene rubber), HNBR (hydrogenated NBR), CHR (epichlorohydrin rubber), and ACM (acrylate rubber), or fluoropolymer-type binders such as PVDF (polyvinylidene fluoride), PTFE (polytetrafluoroethylene), and combinations thereof. Some binders, such as rubber-type binders, may also include an additive such as CMC (carboxymethylcellulose).

Examples of electronically conductive materials that may be included in the electrode material(s) include carbon black (such as Ketjen™, Denka™, Shawinigan carbons, acetylene black, etc.), graphite, graphene, carbon nanotubes, carbon fibers (including carbon nanofibers, vapour grown carbon fibers (VGCF), etc.), non-powdery carbon obtained by carbonization of an organic precursor (e.g., as a coating on particles), or a combination of two or more of these.

The present document also relates to a battery or electrochemical accumulator comprising at least one electrochemical cell as defined herein. For instance, wherein the battery can be selected from a lithium battery, a lithium-ion battery, a sodium battery, a sodium-ion battery, a potassium battery, a potassium-ion battery, a magnesium battery, and a magnesium-ion battery. Preferably, the battery is a lithium battery or a lithium-ion battery.

The batteries and electrochemical accumulators described herein are intended, for example, for use in portable devices, such as mobile phones, cameras, tablets or laptops, in electric or hybrid vehicles, or in the storage of renewable energy.

### EXAMPLES

The following examples are for illustrative purposes and should not be construed as further limiting the scope on the invention as contemplated. These examples will be better understood by referring to the attached Figures.

Unless otherwise indicated, all numbers expressing ingredient amounts, reaction conditions, concentrations, properties, stabilities, etc. used in the application and claims are to be understood as being modified in all instances by the term “about.” At a minimum, each numerical parameter is to be interpreted in light of the number of significant digits reported and by applying customary rounding techniques. Accordingly, unless otherwise indicated, the numerical parameters set forth in the present application and the appended claims are approximations which may vary depending on the properties sought to be achieved. Notwithstanding that the numerical ranges and parameters defining the general scope of the embodiments are approximations, the numerical values set forth in the specific examples are reported as accurately as possible. However, any numerical value inherently contains some errors resulting from variations in experiments, test measurements, statistical analyses, etc.

### Example 1—Preparation of Electrolyte Films

In the following examples, the Polymer 1 is a four-branch star-shaped multi-branch polymer of the polyether type and comprising crosslinkable units at the end of the branch as described in U.S. Pat. No. 7,897,674. The composition of Films 1 to 10 is as shown in Table 1.

TABLE 1
Composition electrolyte films

| | Integrated polymer(s) | | Polymer 1 | Plasticizer^{f} | LiTFSI | Additive^{g} |
|---|---|---|---|---|---|---|
| Film | Type | (weight %) | (weight %) | (weight %) | (weight %) | (weight %) |
| 1 | — | — | 80 | — | 20 | — |
| 2 | PS-NP^{a} | 11.96 | 20.28 | 28.36 | 21.24 | 17.70 |
| 3 | PS-NP-2^{b} | 12.26 | 20.04 | 28.51 | 21.38 | 17.81 |
| 4 | PS-NP-2 | 12.44 | 20.00 | 28.45 | 30.22 | 8.89 |
| 5 | PVDF-HFP^{c} | 12.03 | 20.04 | 25.87 | 32.93 | 8.91 |
| 6 | PVDF-HFP | 15.37 | 16.72 | 25.87 | 32.93 | 8.91 |
| 7 | PS-NP + PVDF- | 12.32 PS- | 15.62 | 28.49 | 30.25 | 8.89 |
| | HFP | NP + 4.43 | | | | |
| | | PVDF-HFP | | | | |
| 8 | CNF^{d} + PVDF- | 1.08 | 20.21 | 25.78 | 32.81 | 8.91 |
| | HFP (V5.3) | CNF + 10.99 | | | | |
| | | PVDF-HFP | | | | |
| 9 | CNF + PVDF- | 12.08 | 19.80 | 25.82 | 32.86 | 9.22 |
| | HFP (V5.3) | (2.06 + 10.08) | | | | |
| 10 | Copolymer^{e} + | 12.04 | 20.10 | 25.92 | 32.99 | 8.95 |
| | PVDF-HFP | (7.79 + 4.25) | | | | |
| | (V5.2) | | | | | |

^{a}PS-NP = poly[styrene-b-poly(poly(ethylene glycol) methyl ether methacrylate-co-methacrylic acid)] (PS-b-P(PEGMA-co-MAA) nanoparticles, PEGMA Mₙ of about 950 g/mol;
^{b}PS-NP-2 = poly[poly(styrene-co-divinylbenzene)-b-poly(poly(ethylene glycol) methyl ether methacrylate-co-methacrylic acid)] (P(S-co-DVB)-b-P(PEGMA-co-MAA) nanoparticles, PEGMA Mₙ of about 950 g/mol;
^{c}The molar weight M_{w} of PVDF-HFP is of about 400 000 g/mol;
^{d}CNF = phosphorus-containing cellulose nanofibers;
^{e}Copolymer = poly[(2,2,2-trifluoroethyl methacrylate)-co-(poly(ethylene glycol) methyl ether methacrylate))], PEGMA Mₙ of about 550 g/mol;
^{f}Plasticizer = tetraethylene glycol dimethyl ether (TEGDME);
^{g}Additive = 1,1′-(1,6-hexamethylene) bis(1-methylpyrrolidinium) bis(trifluoromethanesulfonyl)imide;

### a) Film 1 (Reference)

2 g of lithium bis(trifluoromethanesulfonyl)imide (LiTFSI), 8 g of Polymer 1 and 0.08 g of Irgacure™ were mixed in a flask at room temperature. Once a homogeneous solution was obtained, the solution was coated onto a thin stainless-steel sheet. After UV irradiation under nitrogen for 3 minutes, Film 1 of solid polymer electrolyte was thus obtained.

### b) Film 2

Poly[styrene-b-poly(poly (ethylene glycol methyl ether methacrylate)-co-methacrylic acid)] nanoparticles (PS-NPs) were prepared with PEGMA having a Mₙ of about 950 g/mol according to the procedure described in Xuewei Zhang et al., Chemistry—A European Journal, 2014, 20 (47), 15505-15517.

Then, 4.05 g of these PS-NP nanoparticles, 6 g of additive, 9.6 g of TEGDME and 3 g of THF were mixed in a flask at room temperature. After two hours, 6.75 g of Polymer 1 were added. The mixture was stirred with a magnetic bar for one hour. Then, 7.2 g of LiTFSI was added. After 4 hours of stirring, 0.15 g of Irgacure™ was added. The solution was coated on a polypropylene film. The solvent was evaporated at 20° C. After UV irradiation under nitrogen for 5 minutes, Film 2 of solid polymer electrolyte was thus obtained.

### c) Film 3

The macromolecular chain transfer agent poly(ethylene glycol methyl ether methacrylate)-co-methacrylic acid) trithiocarbonate (macroCTA) was prepared as described in reference Xuewei Zhang et al. (see (b) for reference).

Then, 0.36 g of macroCTA, 1.92 g of LiTFSI, 2.56 g of TEGDME were mixed in a flask at 60° C. After two hours, the solution was cooled, and 0.72 g of styrene, 0.018 g of divinylbenzene (para:meta mixture of approximately 4:1) and 0.0013 g of AIBN were added. The solution was deoxygenated at 0° C. for 30 minutes, then heated to 80° C. with stirring for 4 hours to obtain PS-NP-2 nanoparticles. After cooling, 2 g of THF and 1.6 g of additive were added. Once a homogeneous emulsion was obtained, 1.8 g of Polymer 1 and 0.15 g of Irgacure™ were added. After stirring for 1 hour, the solution was coated onto a polypropylene film and the solvent was evaporated at 20° C. After UV irradiation under nitrogen for 5 minutes, Film 3 of solid polymer electrolyte was thus obtained.

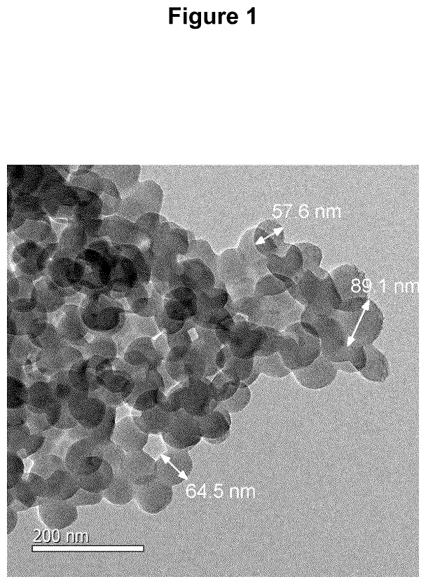

FIG. 1 shows a transmission electron microscopy (TEM) image of the PS-NP-2 nanoparticles before the addition of the other components of the solid electrolyte.

### d) Film 4

The Film 4 was prepared following the preparation protocol for Film 3 described in (c). The proportions of each component are as indicated in the above Table 1.

### e) Film 5

PVDF-HFP (1.08 g) with a molar weight (M_{w}) of approximately 400,000 g/mol was dissolved in 7 g of acetone in a flask at 50° C. After cooling, 0.8 g of additive was added, and the solution was stirred at 50° C. for 4 hours. Then, 2.96 g of LiTFSI and 2.32 g of TEGDME were added. The solution was stirred at room temperature for 2 hours. 1.8 g of Polymer 1 and 0.02 g of Irgacure™ were added. After stirring for 1 hour, the solution was coated onto a polypropylene film. The solvent was evaporated at 20° C. After UV irradiation under nitrogen for 5 minutes, the solid polymer electrolyte Film 5 was thus obtained.

### f) Film 6

The Film 6 was prepared following the preparation protocol for Film 5 described in (e). The proportions of each component are as indicated in the above Table 1.

### g) Film 7

The synthesis of PS-NP-2 was carried out as described above for Film 3, using the same quantities. After the synthesis was completed, a solution of PVDF-HFP (0.4 g) in acetone (6 g) and 0.8 g of additive were added. The mixture was stirred at 60° C. for 4 hours. Then, 1.4 g of Polymer 1 and 0.02 g of Irgacure™ were added at room temperature. After 1 hour of stirring, the solution was coated onto a polypropylene film and the solvent was evaporated at 20° C. After UV irradiation under nitrogen for 5 minutes, the solid polymer electrolyte Film 7 was thus obtained.

### h) Film 8

The Film 8 was prepared following the preparation protocol for Film 5 described in (e). The phosphorus-containing cellulose fibers (CNF) were added before the addition of Polymer 1. The proportions of each component are as indicated in Table 1 above.

### i) Film 9

The Film 9 was prepared following the preparation protocol for Film 5 described in (e). The phosphorus-containing cellulose fibers (CNF) were added before the addition of Polymer 1. The proportions of each component are as indicated in Table 1 above.

### j) Film 10

2.96 g of LiTFSI and 2.32 g of TEGDME were well mixed in a flask at 80° C. for 24 hours. 0.6 g of 2,2,2-trifluoroethyl methacrylate, 0.1 g of poly(ethylene glycol) methacrylate (Mₙ≈500 g/mol) and 0.002 g of AIBN were added at room temperature. After 30 minutes of deoxygenation, the solution was heated to 80° C. with stirring for 1 hour. A solution of PVDF-HFP (0.38 g) in acetone (3 g) and 0.8 g of additive were then added at room temperature. The solution was stirred at 60° C. for 4 hours. 1.8 g of Polymer 1 and 0.02 g of Irgacure™ were added at room temperature. After stirring for 1 hour, the solution was coated onto a polypropylene film and the solvent was evaporated at 20° C. After UV irradiation under nitrogen for 5 minutes, the solid polymer electrolyte film was thus obtained.

### Example 2—Physicochemical Properties

### a) Differential Scanning Calorimetry

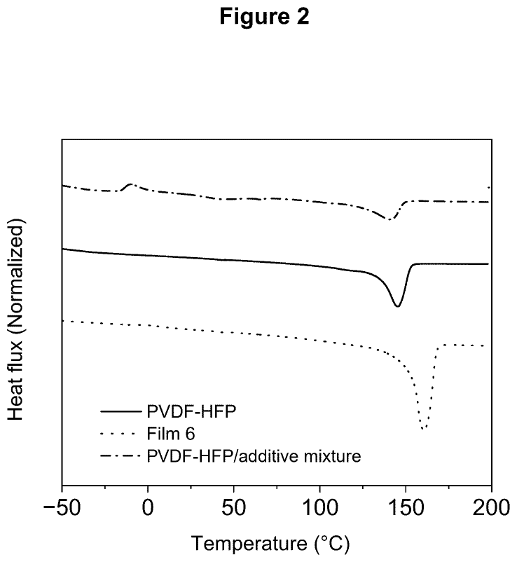

The thermal behavior of a PVDF-HFP film, a PVDF-HFP/ionic additive mixture film (weight ratio: 1.725/1, identical to that of Film 6) and Film 6 was studied with a TA® DSC2500 instrument under nitrogen between −50° C. and 200° C., with a heating and cooling rate of 10° C./min. Air was used as the analytical reference. The instrument was calibrated with indium before analysis. The results obtained are shown in FIG. 2.

The PVDF-HFP/ionic additive mixture shows a lower crystallinity rate compared to that of PVDF-HFP alone. This indicates an interaction between the PVDF-HFP chain and the additive molecules. In contrast, the crystallinity rate of Film 6 is higher than that of PVDF-HFP. This phenomenon could be explained by a reorganization of PVDF-HFP chains in the presence of LiTFSI salt. According to the electrochemistry result, this chain reorganization would promote battery cycling.

### b) Young's Modulus of the Membrane

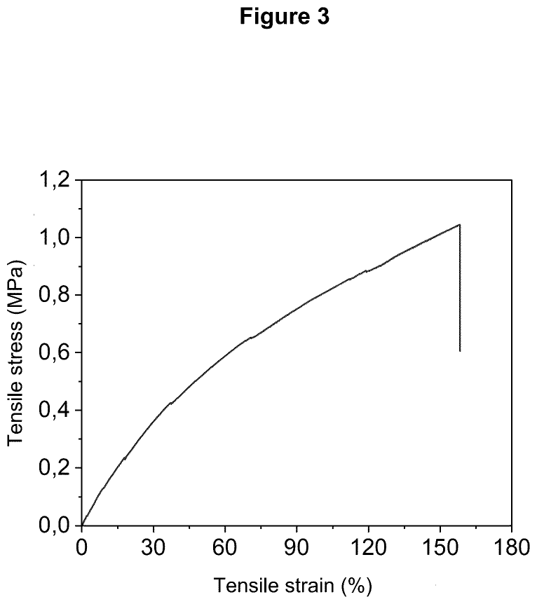

The Young's modulus was evaluated at 20° C. for the membrane prepared in Example 1 (f) containing Film 6 on an Instron® 5944 instrument. The film size for measurement is 50 mm×13 mm×0.045 mm (length×width×thickness). The speed is 100 mm/min. FIG. 3 shows a graph of the Young's modulus of the Film 6 membrane. The Young's modulus of this membrane is of 1.5 MPa.

### c) Diffusion Coefficient

The ionic diffusion coefficient of the different elements of the films prepared in Example 1 (4 and 5) was evaluated by pulsed field gradient solid state NMR spectroscopy of the ¹H, ⁷Li, and ¹⁹F nuclei. The NMR experiments were carried out on a 500 MHz NMR spectrometer equipped with a Diff50™ probe and ⁷Li-¹⁹F and ¹H-¹⁹F double resonance RF inserts.

Measurements were performed from 5° C. to 70° C. The gradient pulse was in the range of 1.0 to 2.0 ms and the diffusion time was in the range of 40 to 100 ms depending on the nucleus. The gradient strength was varied in 16 steps from 100 G/cm to 2500 G/cm.

Diffusion measurements were accompanied by T2 relationship experiments using a CPMG pulse sequence with an echo delay of 0.06 to 0.6 ms. Up to 64 echoes were collected per experiment. The results are shown in Table 2.

TABLE 2
Diffusion coefficients mesured by NMR spectroscopy

| | | TFSI⁻ | Li⁺ | |
|---|---|---|---|---|
| Film | Temp. | (m²/s) | (m²/s) | t⁺ |
| 4 | 50° C. | 1.1 × 10⁻¹¹ | 7.6 × 10⁻¹² | 0.41 |
| | 25° C. | 3.4 × 10⁻¹² | 2.1 × 10⁻¹² | 0.39 |
| 5 | 50° C. | 8.1 × 10⁻¹² | 5.2 × 10⁻¹² | 0.39 |
| | 25° C. | 2.2 × 10⁻¹² | 1.3 × 10⁻¹² | 0.38 |

The transference number “t⁺” is calculated based on the assumption of complete dissociation of the salt without formation of ion aggregates.

### Example 3—Electrochemical Properties

### a) Assembling the Cells (Symmetrical Batteries)

Symmetrical coin cells of the Stainless Steel/Electrolyte/Stainless Steel type were assembled for ionic conductivity measurement. Polymer electrolyte membrane discs were cut with a diameter of 16 mm and clamped between two electrodes. The configuration of each cell is shown as follows (Electrode=Stainless Steel):
1 Cell 1: Electrode/Example 1 (Film1)/Electrode;
Cell 2: Electrode/Example 1 (Film3)/Electrode;
Cell 3: Electrode/Example 1 (Film5)/Electrode; and
Cell 4: Electrode/Example 1 (Film8)/Electrode.

### b) Ionic Conductivity

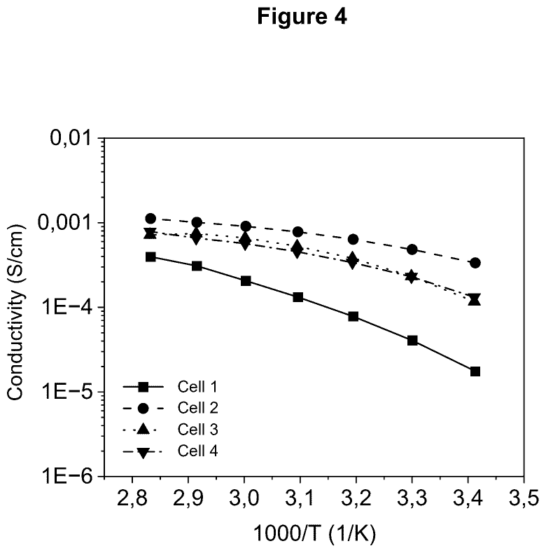

Electrochemical impedance spectroscopy was performed with a Bio-logic® VMP-300 system at an amplitude of 100 mV and frequency range of 1 MHz to 200 mHz. The results are shown in Table 3 hereinbelow. FIG. 4 also shows the ionic conductivity of Cells 1 to 4.

### c) Assembly of Complete Batteries

A cathode was prepared as described in international patent application WO2023/133640 using about 75.6 wt. % of lithium nickel manganese cobalt oxide (LiNi_{0.8}Mn_{0.1}Co_{0.1}O, NMC811), at a loading rate of about 8 mg/cm². The electrolyte film was bonded onto the cathode under pneumatic pressure at 75 psi and 50° C. for 5 min. A lithium metal foil with a thickness of about 50 μm was bonded onto the electrolyte film as anode. A 3.88 cm² coin cell was then assembled to evaluate the performance.

Complete cells using the solid electrolytes described in Example 1 (Films 2-10) were assembled and their performance was evaluated. The configuration of each cell is shown as follows (NMC811=NMC811 cathode above, Li=40-50 μm-thick lithium metal anode):
Battery 1: NMC811/Example 1 (Film 2)/Li
Battery 2: NMC811/Example 1 (Film 3)/Li
Battery 3: NMC811/Example 1 (Film 4)/Li
Battery 4: NMC811/Example 1 (Film 5)/Li
Battery 5: NMC811/Example 1 (Film 6)/Li
Battery 6: NMC811/Example 1 (Film 7)/Li
Battery 7: NMC811/Example 1 (Film 8)/Li
Battery 8: NMC811/Example 1 (Film 9)/Li
Battery 9: NMC811/Example 1 (Film 10)/Li

A reference battery is also prepared in the same manner with Film 1 presented in Example 1.

### d) Performance of Complete Batteries

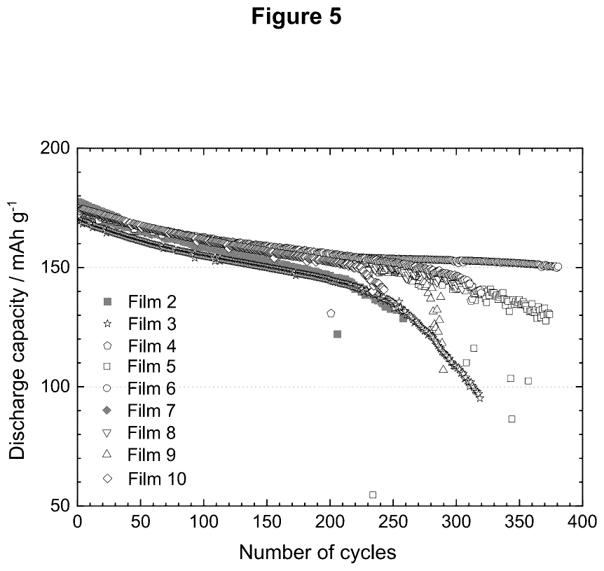

The performance evaluation was achieved on a Bio-Logic® BCS-810 system with a voltage of 2.75-4.2 V and a charge-discharge rate of C/6-1C and C/3-1C (1C=1.2 mA/cm²) at 45° C. The battery capacity is approximately 4.4 mAh (1.2 mAh/cm²). FIG. 5 shows the capacity of a battery including Films 2 to 10 (Batteries 1 to 9) as a function of the number of cycles. Table 3 also shows the number of cycles reached before reaching a capacity loss of 20%.

TABLE 3
Conductivity and cycling results using Films 1 to 10

| | Results | | | | |
|---|---|---|---|---|---|
| | | Conductivity | | Number of cycles | |
| | Cell | (S/cm) at | Battery | C/6 - | C/3 - |
| Film | (symmetrical) | 40° C. | (complete) | 1 C | 1 C |
| 1 | 1 | 7.81 × 10⁻⁵ | Reference | — | N/D |
| 2 | N/D | N/D | 1 | ~200 | N/D |
| 3 | 2 | 6.36 × 10⁻⁴ | 2 | ~200 | N/D |
| 4 | N/D | N/D | 3 | ~300 | ~210 |
| 5 | 3 | 3.81 × 10⁻⁴ | 4 | ~300 | ~280 |
| 6 | N/D | N/D | 5 | ~400 | N/D |
| 7 | N/D | N/D | 6 | ~200 | N/D |
| 8 | 4 | 3.39 × 10⁻⁴ | 7 | ~300 | N/D |
| 9 | N/D | N/D | 8 | ~350 | N/D |
| 10 | N/D | N/D | 9 | ~200 | ~300 |

N/D: Not determined

The cycling of the reference battery failed at C/6-1C, which is believed to be due to a poor adhesion between the electrolyte film and the metallic lithium.

Various modifications could be made to any of the embodiments described above without departing from the scope of the present invention as contemplated. The references, patents or scientific literature documents referred to in this application are incorporated herein by reference in their entirety and for all purposes.

What is claimed is:

1. Solid electrolyte comprising a first polymer, a second polymer, optionally a plasticizer, and optionally an ionic organic additive, wherein the first polymer is a branched polyether with at least 3 branches, and wherein the first and second polymers are different and form a heterogeneous mixture.

2. Solid electrolyte according to claim 1, wherein the first polymer is a branched polyether with at least 4 branches in a star configuration; and/or wherein the branches of the first polymer comprise polymer chains of alkylene oxide units, preferably the alkylene oxide units comprising ethylene oxide units, propylene oxide units or a combination of ethylene oxide and propylene oxide units.

3. (canceled)

4. (canceled)

5. Solid electrolyte according to claim 1, wherein;
the first polymer is crosslinkable and comprises crosslinkable groups, for example located on a side chain or as a terminal group at the end of a branch, preferably as a terminal group at the end of a branch; or
the first polymer is further crosslinked, the polymer being the product of the crosslinking of crosslinkable groups, for example located on a side chain or as a terminal group at the end of a branch, preferably as a terminal group at the end of a branch of the first polymer;
the crosslinkable groups being preferably selected from vinyl, acrylate, methacrylate, glycidyl, and mercapto groups, and a combination of at least two of these.

6. (canceled)

7. (canceled)

8. Solid electrolyte according to claim 1, wherein the first polymer has a number average molecular weight of 500 to 5 million, or 5,000 to 1,000,000, or 20,000 to 500,000; and/or the first polymer is present at a concentration of about 5% to about 80%, about 5% to about 60%, about 5% to about 35%, or about 10% to about 30%, or about 12% to about 25%, by weight in the solid electrolyte.

9. (canceled)

10. Solid electrolyte according to claim 1, wherein the second polymer comprises a substituted polyethylene chain, the second polymer preferably comprising groups selected from fluorine, an optionally fluorinated alkyl group, an optionally substituted cycloalkyl group, an optionally substituted heterocycloalkyl group, an optionally substituted aryl group, an optionally substituted heteroaryl group, a polyether group, an optionally fluorinated alkyl ester group, a polyether ester group, or a combination of two or more thereof.

11. (canceled)

12. Solid electrolyte according to claim 1, wherein the second polymer comprises a copolymer, the second polymer preferably comprising a copolymer comprising units comprising groups selected from fluorine, an optionally fluorinated alkyl group, an optionally fluorinated alkyl ester group, a polyether ester group, or a combination of two or more thereof, and optionally units comprising an optionally substituted aryl group and/or a carboxylic acid group.

13. (canceled)

14. Solid electrolyte according to claim 12, wherein the second polymer comprises a random or block copolymer or a combination of random and block copolymer, the second polymer preferably comprising a block copolymer comprising at least two blocks of different monomers and in which at least one of the two blocks comprises a random copolymer sequence.

15. (canceled)

16. Solid electrolyte according to claim 1, wherein the second polymer comprises at least one monomer derived from the polymerization of poly(ethylene glycol) methyl ether (meth)acrylate, (meth)acrylic acid, 1,1-difluorovinyl, tetrafluorovinyl, hexafluoropropene, 2,2,2-trifluoroethyl (meth)acrylate, styrene, divinylbenzene, or a combination of two or more thereof, preferably the second polymer comprises at least one monomer derived from the polymerization of poly(ethylene glycol) methyl ether (meth)acrylate (PEGMA), 1,1-difluorovinyl (PVDF), tetrafluorovinyl (PTFE), hexafluoropropene (HFP), 2,2,2-trifluoroethyl (meth)acrylate, or a combination of two or more thereof, and optionally a monomer derived from the polymerization of (meth)acrylic acid, styrene, and/or divinylbenzene.

17. Solid electrolyte according to claim 16, wherein the second polymer comprises a polymer selected from:
poly[styrene-b-poly(poly (ethylene glycol) methyl ether methacrylate-co-methacrylic acid)] (PS-b-P(PEGMA-co-MAA);
poly[poly(styrene-co-divinylbenzene)-b-poly(poly (ethylene glycol) methyl ether methacrylate-co-methacrylic acid)] (P (S-co-DVB)-b-P(PEGMA-co-MAA);
poly(vinylidene fluoride)-co-hexafluoropropylene; and
poly[(2,2,2-trifluoroethyl methacrylate)-co-(poly(ethylene glycol) methyl ether methacrylate))];
or a combination of at least two thereof.

18. (canceled)

19. (canceled)

20. Solid electrolyte according to claim 1, wherein the second polymer is a mixture of at least two polymers as previously defined, the mixture of at least two polymers preferably comprising at least poly(vinylidene fluoride)-co-hexafluoropropylene.

21. (canceled)

22. Solid electrolyte according to claim 1, wherein;
the second polymer has a number average molecular weight of 500 to 5 million, or 5,000 to 1,000,000, or 20,000 to 500,000; and/or
the second polymer is in the form of particles (e.g., microparticles, nanoparticles, picoparticles, or a mixture comprising two or more thereof), for example, in the form of powder, fibers, rods, vesicles, micelles, etc.;
the second polymer is present at a concentration of about 3% to about 40%, about 4% to about 30%, 4% to about 25%, or about 8% to about 20%, or about 10% to about 18%, by weight in the solid electrolyte.

23. (canceled)

24. (canceled)

25. Solid electrolyte according to claim 1, which further comprises a third polymer different from the first and second polymers, preferably the third polymer being an optionally substituted, preferably phosphorus-containing, polysaccharide (such as cellulose fibers), or a combination thereof.

26. (canceled)

27. Solid electrolyte according to claim 1, wherein the ionic organic additive is present, preferably at a concentration of about 0.5% to about 35%, or about 2% to about 30%, or about 5% to about 20%, by weight in the solid electrolyte.

28. Solid electrolyte according to claim 27, wherein the ionic organic additive is a bifunctional ionic molecule of Formula I or II: 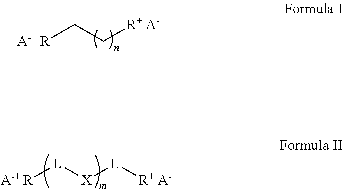
wherein,
A⁻ is a delocalized anion, preferably selected from hexafluorophosphate bis(trifluoromethanesulfonyl)imide (TFSI⁻), bis(fluorosulfonyl)imide (FSI⁻), (flurosulfonyl) (trifluoromethanesulfonyl)imide (FTFSI⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄), bis(oxalato) borate (BOB⁻), nitrate (NO₃⁻), perchlorate (ClO₄⁻), hexafluoroarsenate (AsF₆⁻), trifluoromethanesulfonate (CF₃SO₃⁻ or ⁻OTf), fluoroalkylphosphate ([PF₃(CF₂CF₃)₃]⁻ or FAP⁻), tetrakis(trifluoroacetoxy)borate ([B(OCOCF₃)₄]⁻ or TFAB⁻), bis(1,2-benzenediolato(2-)—O,O′) borate ([B(C₆O₂)₂]⁻ or BBB⁻), difluoro(oxalato)borate (BF₂ (C₂O₄)⁻ or FOB⁻), and an anion of formula BF₂O₄Rₓ (Rₓ=C₂₋₄alkyl), more preferably selected from hexafluorophosphate (PF₆), bis(trifluoromethanesulfonyl)imide (TFSI⁻), bis(fluorosulfonyl)imide (FSI⁻), (flurosulfonyl)(trifluoromethanesulfonyl)imide (FTFSI⁻), tetrafluoroborate (BF₄⁻), and trifluoromethanesulfonate (CF₃SO₃⁻ or ⁻OTf), most preferably the delocalized anion is bis(trifluoromethanesulfonyl)imide (TFSI⁻);
R⁺ is selected from groups —N⁺(R₁R₂R₃) and —P⁺(R₁R₂R₃);
R₁, R₂, and R₃ are independently selected from substituted or unsubstituted, linear or branched C₁₋₁₂alkyl groups; or R₁ and R₂ together with the nitrogen or phosphorous atom form a heterocycle having one or more rings and having from 3 to 12 members and R₃ is as previously defined; or R₁, R₂, and R₃ together with the nitrogen or phosphorous atom form a heteroaromatic or partially unsaturated heterocycle having one or more rings and having from 5 to 12 members;
L is a linear or branched C₂₋₄alkylene;
X is O or S;
m is a number in the range of 1 to 6; and
n is a number in the range of 1 to 11.

29. (canceled)

30. (canceled)

31. (canceled)

32. Solid electrolyte according to claim 28, wherein R⁺ is a —N⁺(R₁R₂R₃) group.

33. Solid electrolyte according to claim 32, wherein:
R₁, R₂, and R₃ are independently selected from substituted or unsubstituted, linear or branched C₁₋₁₂alkyl groups; or
R₁, R₂, and R₃ are independently selected from linear or branched C₁₋₁₂alkyl groups, where at least one of R₁, R₂, or R₃ is substituted by a halogen atom or an alkoxy, ether, ester, or siloxy group; or
R₁ and R₂ together with the nitrogen atom form a heterocycle having one or more rings and having from 3 to 12 members and R₃ is as defined in claim 25, preferably R₃ is a C₁₋₁₂alkyl, or a C₁₋₄alkyl; or
R₁, R₂, and R₃ together with the nitrogen atom form a heteroaromatic or partially unsaturated heterocycle having one or more rings and having from 5 to 12 members.

34. (canceled)

35. (canceled)

36. (canceled)

37. Solid electrolyte according to claim 28, wherein R⁺ is selected from: 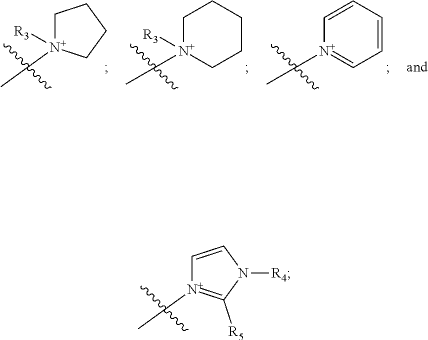
wherein:
R₃ is as defined in claim 28, preferably an unsubstituted C₁₋₄alkyl group, more preferably selected from a methyl group, an ethyl group, an n- or i-propyl group, and an n-, i-, s- or t-butyl group;
R₄ is a substituted or unsubstituted, linear or branched C₁₋₁₂alkyl, C₁₋₁₂alkenyl or C₁₋₁₂alkynyl group, preferably a C₁₋₄alkyl group; and
R₅ is a hydrogen atom or a substituted or unsubstituted, linear or branched C₁₋₁₂alkyl, C₁₋₁₂alkenyl or C₁₋₁₂alkynyl group, and the heterocycle is optionally substituted, preferably a C₁₋₄alkyl group.

38. (canceled)

39. (canceled)

40. (canceled)

41. (canceled)

42. Solid electrolyte according to claim 28, wherein R⁺ is a —P⁺(R₁R₂R₃) group, preferably R₁, R₂, and R₃ being independently selected from substituted or unsubstituted, linear or branched C₁₋₁₂alkyl groups, or R₁, R₂, and R₃ being independently selected from linear or branched C₁₋₁₂alkyl groups, where at least one of R₁, R₂, or R₃ is substituted with a halogen atom or an alkoxy, ether, ester, or siloxy group.

43. (canceled)

44. (canceled)

45. Solid electrolyte according to claim 28, wherein is a number in the range of 2 to 10, or 3 to 8, or 4 to 6,

46. Solid electrolyte according to claim 28, wherein the ionic bifunctional molecule is:
1,1′-(1,6-hexamethylene)bis(1-methylpyrrolidinium) bis(trifluoromethanesulfonyl)imide;
1,1′-(1,12-dodecamethylene)bis(1-methylpyrrolidinium) bis(trifluoromethanesulfonyl)imide;
,1′-(2,2′-(ethylenedioxy) diethane) bis(1-methylpyrrolidinium) bis(trifluoromethanesulfonyl)imide;
1,1′-(thiol bis(1,2-ethane)) bis(1-methylpyrrolidinium) bis(trifluoromethanesulfonyl)imide; or
3,3′-(1,6-hexamethylene) bis(1,2-dimethylimidazolium) bis(trifluoromethanesulfonyl)imide.

47. (canceled)

48. (canceled)

49. (canceled)

50. (canceled)

51. Solid electrolyte according to claim 1, wherein the plasticizer is present, preferably at a concentration of about 5% to about 50%, or about 10% to about 40%, or about 20% to about 30%, by weight in the solid electrolyte, the plasticizer being preferably selected from liquids of the type glycol diethers (such as tetraethylene glycol dimethyl ether (TEGDME)), carbonate esters, ionic liquids, and the like, preferably a glycol diether-type liquid (such as TEGDME).

52. (canceled)

53. Solid electrolyte according to claim 1, which further comprises an alkali metal salt, preferably a lithium salt, preferably at a concentration of about 5% to about 40%, or about 15% to about 40%, or about 20% to about 35%, by weight in the solid electrolyte, the salt preferably comprising a cation of an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (flurosulfonyl) (trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato) borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy) borate [B(OCOCF₃)₄]⁻ (TFAB⁻), bis(1,2-benzenediolato (2-)—O,O′) borate [B(C₆O₂)₂]⁻ (BBB⁻), difluoro (oxalato) borate (BF₂(C₂O₄)⁻) (FOB⁻), an anion of formula BF₂O₄Rₓ⁻ (where Rₓ=C₂₋₄alkyl), and one their combinations, e.g., LiTFSI or LiFSI.

54. (canceled)

55. An electrochemical cell comprising a negative electrode, a positive electrode and an electrolyte, wherein the electrolyte is as defined in claim 1, wherein the positive electrode comprises a positive electrode material comprising a positive electrode electrochemically active material.

56. (canceled)

57. Electrochemical cell according to claim 55, wherein;
the positive electrode material is on a current collector;
the positive electrode electrochemically active material is selected from metal phosphates, lithiated metal phosphates, metal oxides, and lithiated metal oxides; and/or
the positive electrode electrochemically active material is LiM′PO₄ where M′ is Fe, Ni, Mn, Co, or a combination of at least two thereof, LiV₃O₈, V₂O₅F, LiV₂O₅, LiMn₂O₄, Li_{1+w}M″O₂₋ₐX_{b}, where M″ is Mn, Co, Ni, Mg, Al, Zr, W, Ti, Nb, V, Fe, Mo or a combination thereof (such as NMC, Li_{1+w}MnₓCo_{y}Ni_{z}O₂) and X is F, S or a combination thereof, Li_{1+w}(NiM″′)O₂ (where M″′ is Mn, Co, Mg, Al, W, Fe, Cr, Ti, Zr, Nb, Mo, V or a combination thereof), elemental sulfur, selenium or iodine, iron (III) fluoride, copper (II) fluoride, lithium iodide, carbon-based active materials such as graphite, organic cathode active materials, or a combination of two or more of these, when compatible with each other; and/or
the positive electrode material further comprises an electronically conductive material, a binder, a salt, an ionic organic additive, and/or inorganic particles.

58. (canceled)

59. (canceled)

60. (canceled)

61. Electrochemical cell according to claim 55, wherein the negative electrode comprises a negative electrode material comprising a negative electrode electrochemically active material.

62. Electrochemical cell according to claim 61, wherein:
the negative electrode material is on a current collector; and/or
the negative electrode electrochemically active material comprises a metal film comprising an alkali or alkaline earth metal or an alloy comprising an alkali or alkaline earth metal, the alkali metal being preferably selected from lithium and sodium, or an alloy comprising lithium or sodium, preferably lithium or an alloy comprising lithium; and/or
the negative electrode electrochemically active material comprises an intermetallic compound (e.g., SnSb, TiSnSb, Cu₂Sb, AlSb, FeSb₂, FeSn₂ and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and combinations thereof, when compatible, the metal oxide being preferably selected from compounds of formulae M″″_{b}O_{c} (where M″″ is Ti, Mo, Mn, Ni, Co, Cu, V, Fe, Zn, Nb, or a combination thereof; and b and c are numbers such that the c:b ratio is in the range of 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄) and LiM″″′O (where M″″′ is Ti, Mo, Mn, Ni, Co, Cu, V, Fe, Zn, Nb, or a combination thereof) (e.g., a lithium titanate (such as Li₄Ti₅O₁₂) or a lithium and molybdenum oxide (such as Li₂Mo₄O₁₃)); and/or
the negative electrode material further comprises an electronically conductive material, a binder, a salt, an ionic organic additive, and/or inorganic particles.

63. (canceled)

64. (canceled)

65. (canceled)

66. (canceled)

67. (canceled)

68. A battery comprising at least one electrochemical cell as defined in claim 55, said battery being preferably selected from the group consisting of a lithium battery, a lithium-ion battery, a sodium battery, a sodium-ion battery, a potassium battery, a potassium-ion battery, a magnesium battery, and a magnesium-ion battery, more preferably a lithium battery or a lithium-ion battery.

69. (canceled)

70. (canceled)

71. (canceled)
